(19) United States
(12) Patent Application Publication
(10) Pub. No.: US 2005/0172862 A1
(43) Pub. Date: Aug. 11, 2005

(54) Plastic resin delivery and dispensing system for fluid concrete admixtures

(76) Inventor: Zachary T. Rich, Lambertville, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/055,376

(22) Filed: Feb. 10, 2005

Related U.S. Application Data
(60) Provisional application No. 60/543,466, filed on Feb. 10, 2004.

(51) Int. Cl. C04B 7/00

(52) U.S. Cl. 106/638

(57) ABSTRACT

A capsule delivery system provides for the delivery and dispensing of fluid or semi-fluid admixtures into concrete mixes. The capsule is made of a plastic resin and contains a pre-measured dosage of admixture. Once the capsule containing the admixture enters a concrete mix and the concrete mix is agitated mechanically such as via a concrete ready-mix truck, the plastic resin delivery and dispensing capsule shatters and breaks down unnoticeable to the unaided eye, releasing the encapsulated admixture into the concrete mix.

### CROSS REFERENCES TO RELATED APPLICATIONS

This application claims the benefit under 35 U.S.C. 119(e) of U.S. Provisional Application Ser. No. 60/543,466, entitled Plastic Resin Delivery and Dispensing System for Fluid Concrete Admixtures, filed on Feb. 10, 2004.

### FIELD OF THE INVENTION

This invention relates to containers and more particularly to containers for concrete admixtures.

### BACKGROUND OF THE INVENTION

Concrete admixtures modify the properties of concrete during and after manufacturing. Concrete admixtures help concrete achieve higher quality, maintain consistent concrete quality throughout the mix, and can be added when emergency situations arise. Liquid admixtures including, but not limited to, retarders or delay setting chemicals, air entrainers, air detrainers, accelerate setting, corrosion inhibitors, admixtures to reduce potential for alkali aggregate reactivity, bonding admixtures, water-reducers, super plasticizers (high range water reducers), natural and synthetic coloring admixtures, damp proofing, shrinkage reducing admixtures, anti-washout admixtures, hydration stabilizing or extended set retarding admixtures, grouting agents, gas forming agents, permeability reducers, fibers, pumping aids and others have become staples in admixtures.

It is important that the concrete be dosed with the correct amount of admixture because too little admixture may not impact the entire mix and too much admixture can overwhelm and have adverse effects on the concrete mix. The correct measurement of the volume of admixture added to the concrete mix is crucial and varies in each situation with all of the variables involved.

Typically, the method of introducing liquid or dry admixtures into concrete is with the concrete manufacturing batch plant. It can be very troublesome though to have a ready-mix truck pull under the batch plant chute, receive the needed admixture, pull out from under the batch plant, and wait while the admixture is mixed properly throughout the concrete mix. This is an inefficient method and requires too much time. Another problem is admixture waste involved with the use of bulk blending stations to introduce admixtures in concrete mixes.

Another method of introducing admixtures is having tanks mounted on ready-mix trucks. High range water reducers can typically be added to a concrete mix in this manner. The problem with this method is the human guesswork and inefficiency involved with adding the proper amount of admixture.

There is a need for a simplified delivery solution to introducing pre-measured admixtures into concrete with a dispensing package that is not temperature sensitive to melting or freezing, maintains durable and strength qualities while the package is in shipping or being carried, and which essentially breaks down unnoticeable to the unaided eye in the concrete mix thereby releasing a pre-measured liquid admixture into a concrete mix.

### SUMMARY OF THE INVENTION

The present invention is a device for delivery of a semi-fluid or fluid concrete admixture for a concrete mix to be mechanically agitated. A hollow capsule body is at least partially filled with the admixture. The hollow capsule body has a plurality of groove like indentations, where the mechanical agitation of the concrete mix breaks said hollow capsule body releasing the admixture.

### BRIEF DESCRIPTION OF THE DRAWINGS

A more complete understanding of the present invention may be obtained from consideration of the following description in conjunction with the drawings in which:

FIG. 1 is a perspective view of the Delivery And Dispensing Capsule;

FIG. 2 is a side view of the Delivery And Dispensing Capsule;

FIG. 3 is a bottom view of the Delivery And Dispensing Capsule;

FIG. 4 is a top view of the Delivery And Dispensing Capsule; and,

FIG. 5 is a cross-section side view of the Delivery And Dispensing Capsule.

### DETAILED DESCRIPTION OF VARIOUS ILLUSTRATIVE EMBODIMENTS

Although the present invention is particularly well suited for the delivery and dispensing of fluid concrete admixtures and shall be so described herein, it is equally well suited for the delivery of semi-fluid concrete admixtures and a variety of other concrete admixtures.

The present invention, Plastic Resin Delivery And Dispensing System For Fluid Concrete Admixtures is a capsule delivery system comprised of a plastic resin containing a pre-measured dosage of admixture. Once the capsule enters a concrete mix and the concrete mix is agitated mechanically via a concrete ready-mix truck, the plastic resin delivery and dispensing capsule shatters and breaks down unnoticeable to the unaided eye, releasing the encapsulated admixture into the concrete mix. The present invention also discusses modifying the properties of a concrete mix by introducing a plastic resin delivery and dispensing capsule designed to shatter and break down releasing the contained pre-measured dosage of admixture.

The present invention is a new plastic delivery and dispensing packaging system that releases pre-measured concrete admixture dosages to concrete mixes. The present invention resolves many of the stated problems with the packaging capsule being formed of plastic resin. The object of the plastic resin formed delivery and dispensing capsule is to provide an efficient and economical method of dosing concrete with a pre-measured amount of liquid admixture.

Accordingly, an object of the present invention is to provide a pre-measured amount of liquid concrete admixture encapsulated in a plastic resin container that will be added to a concrete mix. The plastic resin container will shatter and break down unnoticeable to the unaided eye once the concrete mix is agitated mechanically, thereby releasing the liquid admixture into the concrete mix.

Another object of the present invention is to have the unique ability of the delivery and dispensing capsule being made of a plastic resin that is not temperature sensitive to melting or freezing, and which maintains durability and strength qualities while being transported or carried. An objective of the plastic resin capsule containing a pre-measured dosage of liquid concrete admixture is very unique in that it will completely break down unnoticeable to the unaided eye in the concrete mix once agitated mechanically in a concrete mix. This is due to the plastic resin capsule having brittle-like qualities once the capsule begins to break and rupture.

A further objective of the present invention is that a plastic resin is utilized which allows remarkable performance that forms the capsule walls for the encased liquid admixture. The plastic resin allows the walls to be thinner and require less material than other potential materials. This advancement allows for a smaller amount of packaging material carrying the liquid admixture to be introduced into a varying amount of concrete mix.

Admixtures are used to modify the properties of concrete during and after the manufacturing of concrete. This is important because admixtures can help concrete achieve a higher quality concrete than concrete by itself, admixtures maintain consistent concrete quality throughout the mix, and admixtures can be added during emergency situations. Liquid admixtures including, but not limited to, retarders or delay setting chemicals, air entrainers, air detrainers, accelerate setting, corrosion inhibitors, admixtures to reduce potential for alkali aggregate reactivity, bonding admixtures, water-reducers, super plasticizers (high range water reducers), natural and synthetic coloring admixtures, damp proofing, shrinkage reducing admixtures, anti-washout admixtures, hydration stabilizing or extended set retarding admixtures, grouting agents, gas forming agents, permeability reducers, fibers, pumping aids and others have become staples in admixtures.

Dosing concrete with the correct amount of admixture is important because too little admixture may not impact the entire mix, but too much admixture can overwhelm and have adverse effects on the concrete mix. Correct measurement of the amount of admixture added to the concrete mix is crucial and can vary in each situation taking into consideration all of the variables involved.

A current method of introducing liquid or dry admixtures into concrete is with the concrete manufacturing batch plant. It can be very troublesome though to have a ready-mix truck pull under the batch plant chute, receive the needed admixture, pull out from under the batch plant, and wait while the admixture is mixed properly throughout the concrete mix. This is an inefficient method and requires too much time. Another problem is, admixture waste involved with the use of bulk blending stations to introduce admixtures in concrete mixes.

Another method of introducing admixtures is having tanks mounted on ready-mix trucks. High range water reducers can typically be added to a concrete mix in this manner. The problem with this method is the human guesswork and inefficiency involved with adding the proper amount of admixture.

Smith et al., U.S. Pat. No. 4,961,790, discloses a dispensing method for a measured amount of solid or dry admixtures utilizing a water soluble package that once is introduced into a concrete mix dissolves thereby releasing the admixture into the mix.

The problems associated with this method include using dry, solid admixtures which do not mix as well as liquid admixtures, and the water soluble package depends on the water in the wet mix to break down. Another problem is the packaging may not completely dissolve, thereby not evenly releasing the solid or dry admixture into the concrete mix and the undissolved bag may be seen in the concrete mix. This method also does not address dispensing pre-measured fluid concrete admixtures via a packaging system.

de Mars et al., U.S. Pat. No. 5,320,851, discloses a method for introducing liquid admixtures into concrete mixes in a dispensing package formed of wax. The wax packaging device encapsulates pre-measured fluid admixtures that can be added to concrete mixes. The wax packaging container ruptures upon mechanically agitating the concrete. The associated problems of the wax packaging are it is temperature sensitive in that the wax is prone to melting or freezing while it is transported or in shipping, and the wax container does not fully break down when mixed in a concrete mix.

Currently, there is a need for a viable, simplified delivery solution to introducing pre-measured liquid admixtures into concrete with a dispensing package that is not temperature sensitive to melting or freezing, maintains durable and strength qualities while the package is in shipping or being carried, but essentially breaks down unnoticeable to the unaided eye in the concrete mix due to it's brittleness once the packaging capsule is broken thereby releasing a pre-measured liquid admixture into a concrete mix.

The present invention is a newly engineered device consisting of a plastic resin dispensing container and a pre-measured dosage of fluid or semi-fluid concrete admixture in the plastic resin dispensing container. The present invention could be made from, but not limited to, plastic resin, epoxy, polymer, or ceramic. The present invention could be made from, but not limited to, plastic resins such as polyethylene terephthalate (PET, PETE), high density polyethylene (HDPE), vinyl (Polyvinyl Chloride or PVC), low density polyethylene (LDPE), polypropylene (PP), polystyrene (PS), styrene (S), polyurethane elastomer, acrylic, thermoplastic hydrocarbon resin or a combination of the listed plastic resins. The uniqueness in the plastic resin formed for the delivering and dispensing capsule is that the plastic resin is a reversal of traditional theory. Typically, plastic resin is designed to be strong, tough and not able to break easily. The present invention is the opposite and calls for the development of a plastic resin that is durable as a whole, but once broken will shatter to unnoticeable pieces due to its brittle-like qualities. The plastic resin developed for the present invention is a custom-blended, impact-adjusted crystal polystyrene. The hybrid resin consists of standard fillers blended into a basic polystyrene resin which separates and weakens the polystyrene molecule chains. One such suitable custom-blended, impact-adjusted crystal polystyrene is one produced by Lucent Polymers. The custom plastic resin has a 3 g/10 minutes melt flow (200° C., 5.0 kg), 2,300 @ yield, p.s.i. (Mpa) tensile strength, 290,000 p.s.i. (Mpa) flexural modulus, 1.08 specific gravity, and 0.004 in/in mold shrinkage. The hybrid plastic is strong enough to not break in shipping and transit, but is weak enough to break down unnoticeably in the concrete mix. Although polystyrene is the resin best chosen, other plastic resins could potentially be used.

The plastic resin capsules can be manufactured by plastic molding techniques such as, but not limited to, custom injection molding, rotational molding, blow molding, including extrusion and continuous extrusion blow molding, injection molding, and thermoforming molding. The present invention utilizes the blow molding process for quality and production cost reasons. Other methods such as custom injection molding could also be used in the present invention production process. Blow molding produces the plastic capsule in one part and does not require fusing two parts together. This increases the quality and reduces the chance of the present invention leaking, prematurely breaking, and preventing product problems. Blow molding is also a very fast and cost effective method to mold plastic on a large scale. The process for the present invention begins with the plastic polymer resin being added to the blow molding machine and heating the resin to a fluid state. The fluid plastic is then extruded, blown, and molded into the shape and size of the desired capsule. The one-piece hybrid plastic capsule is then released out of the mold, and the concrete admixture is filled either by hand or machine through an opening in the capsule. The capsule opening is then sealed by hand or machine to prevent any leakage. Sealing materials could include, but not limited to glue, plastic, epoxy, ceramic, rubber, or adhesive strips. The plastic resin capsule wall thickness can range between approximately 1/96 inch and ½ inch. The present invention capsule wall thickness is approximately 1/24 inch. Any suitable plastic resin compound that is durable and does not have the tendency to crack or rupture easily, but once broken has brittle qualities, can be used to produce the capsule for the present invention. The plastic resin capsule can be in any shape or color, and range in size to hold approximately 1 ounce to 128 ounces. The plastic resin used in the present invention is a preferred embodiment because it is chemically inert and not harmful to the enclosed admixtures, and the plastic resin will not affect the concrete mix for which it is to be placed. Plastic resin as opposed to other materials has tremendous characteristics of being very durable and strong in the present invention's capsule form, but once mixed with concrete, ruptures and shatters taking on brittle qualities to breakup to the point where the plastic resin is unnoticeable to the unaided eye.

The aesthetics associated with the plastic resin capsule include a cross-sectioned egg shape that is preferably the color gray. The cross sections in the capsule wall help the plastic capsule break down in the concrete mix. However, the shape of the capsule is not limited to an egg shape and can be effective in various forms. The capsule can be in the following geometric configurations including, but not limited to, cylinder, circle, rectangle, square, drum-shape, and oblong. The majority of concrete produced is gray and the plastic resin used in the present invention is tinted gray to benefit the user. The plastic resin capsule will range in size to meet the dosage desired in ounces, but will only be the size required to fill the capsule, which ranges from approximately 1 ounce to 128 ounces. The capsule generally should only be large enough to hold the dosage needs.

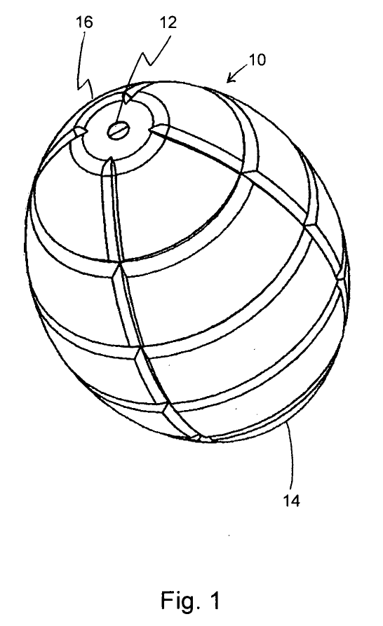

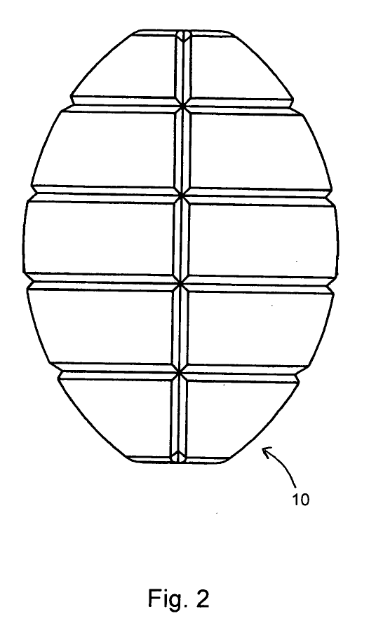

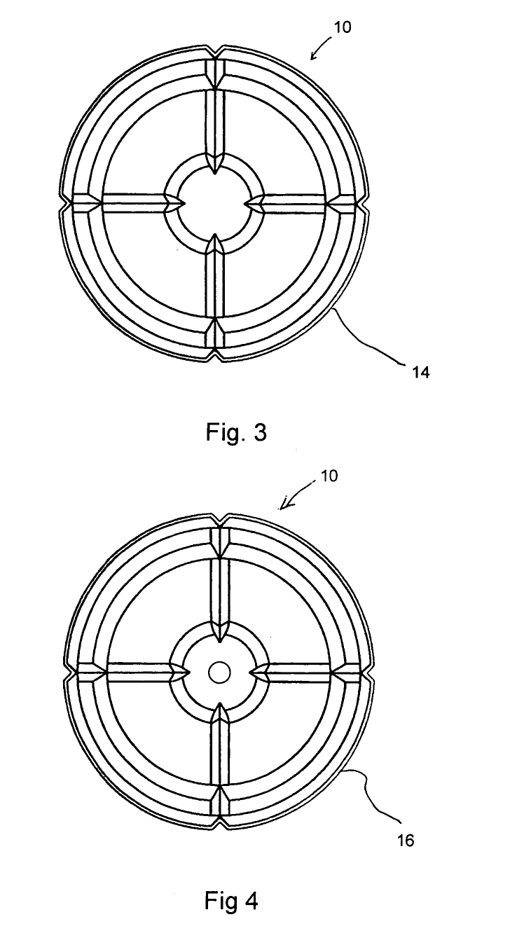

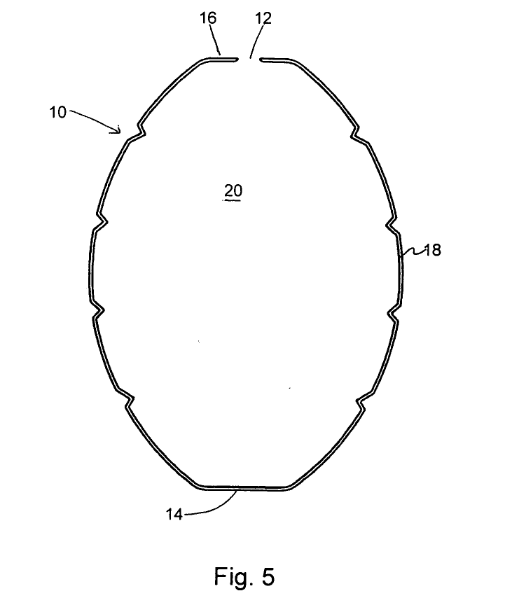

Referring to FIG. 1 in conjunction with FIGS. 2, 3, 4 and 5, there is shown various views of the Delivery And Dispensing Capsule. Referring to FIG. 1 there is shown a perspective view of the Delivery And Dispensing Capsule. Referring to FIG. 2 there is shown a side view of the Delivery And Dispensing Capsule. Referring to FIG. 3 there is shown a bottom view of the Delivery And Dispensing Capsule. Referring to FIG. 4 there is shown a top view of the Delivery And Dispensing Capsule. Referring to FIG. 5 there is shown a cross-section side view of the Delivery And Dispensing Capsule. Similar elements are assigned the same numbers in the various figures.

Referring in particular to FIG. 1, the entire capsule 10 can be clearly seen in the shape of an egg that is flat on bottom and on top with a sealed opening, upright, and filled completely with an admixture. The top of the capsule 16 contains opening 12 where the admixture is filled through an opening and then the capsule (egg) is sealed or plugged with glue, epoxy, plastic, rubber, ceramic, or an adhesive strip to completely enclose the admixture inside the capsule.

Referring to FIG. 5 the bottom 14 of the capsule 10 and how the cross-sectioned egg shape capsule is flat on bottom 14 to allow the capsule 10 to stand upright for packaging and stabilization purposes. The capsule 10 is shown in cross-section. The particular shape and grooving help the capsule break down in a concrete mix. Each cross-section line on the capsule is grooved in and thus promotes areas that allow rocks in the concrete mix to push into the capsule wall and cause fracture points. This enables the capsule 10 to begin breaking down in a concrete mix. It should be noted that the egg shape capsule is thinner at the base, increasing in width towards the middle of the capsule 10, and decreases in width towards the top of the egg shaped capsule. The capsule 10 is in the shape described because the egg-like shape sits in the palm of a hand more comfortably, and also because the egg is stabilized better to stand on its own due to the base being flat. This utilitarian design for the capsule is aesthetically appealing for shipping and packaging purposes, and for daily use of the present invention.

The thin plastic resin wall 18 of the capsule 10 is shown and when the admixture 20 is contained within the capsule 10 the opening 12 is sealed whereby the admixture is encased in the capsule.

Notably, the present invention relates to a device having a pre-measured dosage of liquid concrete admixture contained within this capsule formed of plastic resin such that when the plastic resin capsule containing this concrete admixture is introduced into a wet concrete mix and agitated, the plastic resin capsule is engineered to shatter and break down, and release the concrete admixture into the wet concrete mix. The engineered plastic resin dispensing capsule containing a pre-measured dosage of admixture is introduced into concrete ready-mix trucks and mechanically mixed, thereby agitating the concrete mix within the ready-mix truck, causing the plastic resin dispensing capsule to shatter into unnoticeable pieces and releasing the admixture into the concrete mix.

The present invention is designed to be used by concrete ready-mix producers and concrete contractors. The applicability, versatility, and ability of being able to use a plastic resin capsule that will shatter, become unnoticeable to the unaided eye upon agitation in a concrete mix via a concrete ready-mix truck, and then releasing a pre-measured dosage of concrete admixture within the concrete mix is very desirable.

Unlike the present common practice of adding admixture to a concrete mixture via a bulk concrete mixing station, or via tanks mounted on the side of the concrete ready-mix trucks that release admixtures through hoses into the concrete mix, the present invention capsule permits pre-measured doses to be available for use at the plant as well as in the field as necessary. The present invention is also in contrast to the practice of adding a solid or powdered admixture in a water soluble container, such as polyvinyl alcohol, polyethylene oxide, foam, cellulose, paper products, and cotton products. The present invention delivers liquid admixtures into concrete mixes by way of a plastic resin capsule device that shatters upon agitation. The plastic resin is not water sensitive or dependent upon water to break the capsule down to release the concrete admixture. The present invention is also in contrast to a capsule formed of a water soluble material, including gelatin, glass, polyethylene and other materials such as wax due to the packaging container encapsulating the concrete admixture being a plastic resin.

The present invention is an economical, efficient, and simplified solution for concrete ready-mix producers and concrete contractors. The present invention simplifies the dosage amounts of concrete admixtures for ease of use, and allows the concrete ready-mix producer and contractor to introduce pre-measured amounts of liquid admixture into their concrete mixes by way of a plastic resin capsule without having to use a batch plant, or a tank mounted on the side of a truck that is inefficient and involves guesswork. The present invention also eliminates the problems associated with dispensing devices that releases admixtures into concrete that are temperature sensitive, water sensitive, and do not break down completely to the unaided eye in the concrete mix. The present invention uses a plastic resin formulated capsule that offers extensive value at introducing admixtures into ready-mix concrete because of the ability of the plastic resin to break down unnoticeable to the unaided eye, yet durable enough in capsule form to not leak, crack, or rupture prior to being placed in a concrete mix and agitated.

The National Ready Mix Concrete Association describes admixtures in the Concrete in Practice Series (CIPS) #15 (which is incorporated by reference herein as if fully set out in detail) as natural or manufactured chemicals added to concrete before or during mixing. The present invention can be used to dispense a range of liquid admixtures into concrete according to CIPS #15 including, but not limited to, retarding or delay setting, air entrainers, air detrainers, accelerate setting, corrosion inhibitors, admixtures to reduce potential for alkali aggregate reactivity, bonding admixtures, water-reducers, super plasticizers (high range water reducers), shrinkage reducing admixtures, anti-washout admixtures, hydration stabilizing or extended set retarding admixtures, pumping aids, natural and synthetic coloring admixtures, damp proofing, grouting agents, gas forming agents, permeability reducers, fibers, and others.

The present invention capsule enables a new method for allowing ready-mix concrete producers to effectively recycle and resell concrete in another order that has already been sold. The plastic resin capsule containing the pre-measured dosage of liquid retarder or delay setting chemicals can be used to change the properties of leftover concrete in the field, allowing the concrete to be re-sold in another load of concrete that has similar specifications. In general, excess concrete is sent back to the bulk manufacturing plant and is wasted by being dumped in large mounds, only later to be crushed. Other uses for excess concrete have included the production of large concrete blocks, but the market value of the concrete in this form tremendously decreases. The present invention's advanced technology of ease of use, simplified dose measurements, and a dispensing capsule that completely breaks down unnoticeably in the concrete mix gives ready-mix producers a new economical method of reselling recycled concrete at market value, while preventing the environmental impact that is associated with waste concrete.

The following are representative examples used to describe possible applications for the present invention and corresponding methods associated therewith.

### EXAMPLE 1

The following is a sales proposal and specialized method for the present invention pertaining to the value and quality that the plastic resin dispensing capsule containing a pre-measured dosage of concrete retarder or delay setting chemicals will have in the recycled concrete market.

Every day concrete is returned to the concrete producer by their customers and is generally wasted. Returned concrete to the concrete producer is a tremendous problem due to its environmental impact, massive piles of waste that are built up at batch plant sites, and the labor and time required to get rid of the hardened mounds of concrete. The present invention allows the concrete ready-mix producer to recycle and resell the returned concrete in another order. The plastic resin dispensing capsules containing a pre-measured dosage of retarder admixture can be kept in a container in the cab of the concrete ready-mix truck. The plastic resin dispensing capsule containing a predetermined dosage of retarder admixture can be added to the leftover concrete in the concrete ready-mix truck prior to returning to the batch plant, thus allowing the admixture to retard the hardening of the concrete for certain lengths of time as the concrete ready-mix truck is returning to the concrete batch plant. Then, fresh concrete can be added to the recycled concrete that has been dosed with a retarder to stop the hydration of the concrete.

A cubic yard of concrete at 3,000 p.s.i. can range from approximately 275-525 pounds of cement depending on whether a pozzolan is present. At 70° Fahrenheit, a 3 oz. per 100 weight of cement retarder will slow the hardening of 1 hour +/−15 minute old concrete for approximately 2 to 2½ hours. A cubic yard of concrete containing approximately 350 pounds of cement will require 10.5 ounces of retarder, or 3 ounce per 100 weight of cement retarder to have approximately 2 to 2½ hours of retardation. The plastic resin capsule is to be added to concrete and agitated mechanically via a ready-mix truck for approximately 10 minutes to cause the plastic resin capsule to shatter, thereby releasing the retarding admixture into the concrete mix. The present invention is valuable due to the plastic resin capsule shattering unnoticeable to the unaided eye, and releasing the retarding admixture into the concrete mix.

Adding a retarding admixture to concrete is not an exact science because there are many variables affecting the hardening rate of concrete. The present invention greatly enhances the ability to be more efficient in dosing concrete with admixtures such as retarders than other methods currently available because of the dispensing capabilities of the plastic resin packaging which shatters and becomes unnoticeable to the unaided eye in the concrete mix.

Ready-mix producers have added and continue to try and add a retarder admixture to the returned concrete at the batch plant. This is done when batching fresh concrete and introducing it into the old or returned concrete, thereby affecting the entire concrete mix and not the old concrete exclusively. The present invention relieves this problem, and simplifies the process by adding a pre-measured dosage of retarding admixture in a plastic resin capsule that will shatter and break down unnoticeably to the unaided eye to leftover concrete prior to returning to the batch plant, and then the retarding admixture has time to take effect on the concrete as the concrete ready-mix truck is returning to the batch plant for fresh concrete. Generally, the present invention filled with a retarding admixture doses the leftover concrete when it is about 1 hour +/−15 minutes old, whereas dosing the returned load at the batch plant is approximately 2 hours +/−15 minutes old. The present invention, filled with a retarding admixture, allows the returned concrete to be in the same reasonable physical state as the fresh concrete that will be added to it. Dosing leftover concrete in the field allows producers to recycle the returned concrete while preventing the risk of quality deterioration when fresh concrete is added to recycled concrete and poured on a following jobsite. It also reduces waste, and prevents associated environmental contamination.

### EXAMPLE 2

Air Entrainment admixtures add microscopic air bubbles into concrete to improve the durability of concrete exposed to moisture during freezing and thawing cycles. Air Entrainment admixtures also increase the flow and workability of concrete, while decreasing bleeding in concrete. It can be particularly useful to be able to add a pre-measured dosage of liquid air entrainment admixture contained in a plastic resin capsule to a concrete mix virtually anytime and anywhere.

Air Entrainment admixtures can be added at approximately 1 ounce per 100 weight of cement, but the dosage may vary. If a cubic yard of concrete at 3,000 p.s.i. contains 350 pounds of cement it will require 3.5 ounces of Air Entrainment. The present invention encapsulating this dosage is required to be added to the 1 yard concrete mix. The plastic resin capsule containing the air entrainment can be added to the concrete mix and agitated mechanically for approximately 10 minutes by a ready-mix truck. This will cause the plastic resin capsule to break down unnoticeable to the unaided eye and release the air entrainment into the mix. This can be done on, or prior to reaching the jobsite, whichever is required to achieve the desired results of using air entrainment.

The uniqueness and value of the present invention is that the plastic resin packaging system not only releases a pre-measured liquid admixture, but breaks down unnoticeable to the unaided eye and does not affect the concrete mix.

All of the numbers used in the example are approximate values and should not be construed as exact values.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

1. An device for delivery of a semi-fluid or fluid concrete admixture for a concrete mix to be mechanically agitated, the device comprising:
a hollow capsule body, the body being a plastic wherein said hollow capsule body is at least partially filled with the admixture;
said hollow capsule body having a plurality of groove like indentations;
whereby the mechanical agitation of the concrete mix breaks said hollow capsule body releasing the admixture.

2. The device for delivery of a semi-fluid or fluid concrete admixture for a concrete mix to be mechanically agitated as recited in claim 1 wherein said hollow capsule body is an integral single structure.

3. The device for delivery of a semi-fluid or fluid concrete admixture for a concrete mix to be mechanically agitated as recited in claim 1 wherein said hollow capsule body has a thickness of between approximately 1/96 of an inch to approximately ½ of an inch.

4. The device for delivery of a semi-fluid or fluid concrete admixture for a concrete mix to be mechanically agitated as recited in claim 1 wherein said hollow capsule body is fractured by the mechanical agitation of the concrete mix.

5. The device for delivery of a semi-fluid or fluid concrete admixture for a concrete mix to be mechanically agitated as recited in claim 1 wherein said hollow capsule body is shattered and fractured by the mechanical agitation of the concrete mix into a size unnoticeable to the unaided eye.

6. The device for delivery of a semi-fluid or fluid concrete admixture for a concrete mix to be mechanically agitated as recited in claim 1 wherein said hollow capsule body is egg shaped.

7. The device for delivery of a semi-fluid or fluid concrete admixture for a concrete mix to be mechanically agitated as recited in claim 1 wherein said hollow capsule body is a plastic resin durable when whole, but is suitably brittle so as to shatter.

8. The device for delivery of a semi-fluid or fluid concrete admixture for a concrete mix to be mechanically agitated as recited in claim 1 wherein said hollow capsule body is impact-adjusted crystal polystyrene.

9. The device for delivery of a semi-fluid or fluid concrete admixture for a concrete mix to be mechanically agitated as recited in claim 8 wherein said impact-adjusted crystal polystyrene is comprised of standard fillers blended into basic polystyrene resin whereby the polystyrene molecule chains separate and weaken.

10. The device for delivery of a semi-fluid or fluid concrete admixture for a concrete mix to be mechanically agitated as recited in claim 8 wherein said impact-adjusted crystal polystyrene has approximately a 3 g/10 minutes melt flow (200° C., 5.0 kg), approximately a 2,300 p.s.i. (Mpa) tensile strength and approximately a 290,000 p.s.i. (Mpa) flexural modulus.

11. A method for delivery and dispensing of a semi-fluid or fluid concrete admixture for a concrete mix to be mechanically agitated, the method comprising the following steps:
forming a hollow plastic capsule body;
introducing the admixture into said hollow plastic capsule body;
sealing said hollow plastic capsule body;
introducing said hollow plastic capsule body into the concrete mix;
whereby the mechanical agitation of the concrete mix breaks said hollow plastic capsule body releasing the admixture.

12. The method for delivery and dispensing of a semi-fluid or fluid concrete admixture for a concrete mix to be mechanically agitated as recited in claim 11 wherein said hollow plastic capsule body is inert to the admixture and the concrete mix.

13. The method for delivery and dispensing of a semi-fluid or fluid concrete admixture for a concrete mix to be mechanically agitated as recited in claim 11 wherein said hollow plastic capsule body has a thickness of between approximately 1/96 of an inch to approximately ½ of an inch.

14. The method for delivery and dispensing of a semi-fluid or fluid concrete admixture for a concrete mix to be mechanically agitated as recited in claim 11 wherein said hollow plastic body is shattered and fractured by the mechanical agitation of the concrete mix into a size unnoticeable to the unaided eye.

15. The method for delivery and dispensing of a semi-fluid or fluid concrete admixture for a concrete mix to be mechanically agitated as recited in claim 11 wherein said hollow plastic body is impact-adjusted crystal polystyrene.

16. The method for delivery and dispensing of a semi-fluid or fluid concrete admixture for a concrete mix to be mechanically agitated as recited in claim 15 wherein said impact-adjusted crystal polystyrene is comprised of standard fillers blended into basic polystyrene resin whereby the polystyrene molecule chains separate and weaken.

17. A method for retarding hydration of residual or returned concrete mix for recycling, the method comprising the following steps:
providing a hollow plastic capsule body containing a semi-fluid or fluid retarder or delay setting chemical admixture;
introducing said hollow plastic capsule body into a ready mix truck;
agitating the concrete wherein said hollow plastic capsule body releases said admixture;
thereby allowing the concrete mix to be recycled in a subsequent load of concrete mix.

18. The method for retarding hydration of residual or returned concrete mix for recycling as recited in claim 17 wherein said hollow plastic capsule body has a thickness of between approximately 1/96 of an inch to approximately ½ of an inch.

19. The method for retarding hydration of residual or returned concrete mix for recycling as recited in claim 17 wherein said hollow plastic body is impact-adjusted crystal polystyrene.

20. The method for retarding hydration of residual or returned concrete mix for recycling as recited in claim 19 wherein said impact-adjusted crystal polystyrene is comprised of standard fillers blended into basic polystyrene resin whereby the polystyrene molecule chains separate and weaken.
